(19) United States
(12) Patent Application Publication
(10) Pub. No.: US 2015/0060278 A1
(43) Pub. Date: Mar. 5, 2015

(54) CYLINDER CAM FOR GEL ELECTROPHORESIS

(71) Applicant: Health Diagnostic Laboratory, Inc., Richmond, VA (US)

(72) Inventors: Philip GUADAGNO, Mechanicsville, VA (US); Erin SUMMERS, Glen Allen, VA (US)

(21) Appl. No.: 14/470,543

(22) Filed: Aug. 27, 2014

Related U.S. Application Data
(60) Provisional application No. 61/974,881, filed on Apr. 3, 2014.
(60) Provisional application No. 61/870,595, filed on Aug. 27, 2013.

(51) Int. Cl. G01N 27/447

(52) U.S. Cl. CPC G01N 27/44743; G01N 27/44782
USPC 204/456; 204/606

(57) ABSTRACT

A cylindrical cam device includes an axle and a plurality of disk portions disposed about the axle. The plurality of disk portions define a plurality of interstitial regions disposed between the plurality of disk portions. Each of the plurality of disk portions comprises a radial edge. The radial edge of each of the plurality of disk portions comprises a material or structure capable of retaining a liquid and releasing at least a portion of the liquid onto a substrate. A method for facilitating electrophoretic analysis of biological samples utilizing the cylindrical cam device is also disclosed.

This application claims the benefit of U.S. Provisional Patent Application Ser. No. 61/974,881 filed Apr. 3, 2014 and U.S. Provisional Patent Application Ser. No. 61/870,595 filed Aug. 27, 2013, both of which are hereby incorporated by reference in their entirety.

### FIELD

The invention is related to the field of electrophoretic analysis of biological specimens, including the application of biological samples to an electrophoresis plate. More specifically, the present invention is directed to a cylindrical cam device and a method for facilitating electrophoretic analysis of biological samples utilizing the cylindrical cam device for in situ electrophoretic analysis of biological samples.

### BACKGROUND

In clinical laboratory practice, various techniques, such as electrophoresis, are used to apply samples to substrates for separation and analysis. Electrophoresis in general is the voltage-driven migration of suspended and/or colloidal particles in a liquid or a gel, due to the effect of a potential difference across immersed electrodes. Electrophoresis is often used in the study of proteins and colloidal particles from biological samples, such as evaluation of lipoparticles and lipoproteins. In many devices that use electrophoresis, the strategy is to apply a sample just to the surface of a substrate, then apply a voltage to separate the components of the sample. This strategy is used in techniques like immunofixation-based electrophoresis and two-dimensional electrophoresis.

In immunofixation methods, such as described in U.S. Patent Application Publication No. 2012/0052594, which is hereby incorporated herein by reference in its entirety, a biological sample (e.g., serum) is applied to a substrate and the components are electrophoresed. Anti-sera containing labeled antibodies that target specific components of the blood are then applied to the substrate. The antibodies attach to their antigen targets, and the targets can be identified through some means of detecting the label.

IFE involves, as a first step, protein fraction resolution by electrophoresis. As a second step, the soluble antigen in each protein fraction is allowed to react with its antibody. The resultant antigen-antibody complexes will precipitate, at a rate dependent upon the proportion of the reactants, temperature, salt concentration, and pH. The antigen-antibody complexes are then visualized by staining. The IFE process is described in greater detail in U.S. Pat. No. 4,668,363, which is hereby incorporated by reference herein in its entirety.

Typically, a specimen from a single patient is diluted and then placed in multiple sample or application areas (also referred to as zones) on a single electrophoretic gel plate. The purpose of utilizing multiple sample areas is to enable detection separately of distinct analyte groups such as total serum protein, lipoprotein, or other proteins whose presence or absence may be of importance in medical diagnosis. Various antisera (i.e., fluid containing the antibody) such as IgG, IgM, etc., are deposited on the appropriate zones and permitted to react with the antigen in the sample. The term “incubation” refers to the time interval during which the antisera and antibody are in contact such that a reaction may occur.

In clinical applications, it is desirable to analyze many samples in parallel on the same substrate. This reduces the cost per sample analyzed and saves substantial time. High throughput instruments and devices, such as the SPIFE 3000 Assay instrument by Helena Laboratories, are made for this purpose.

High throughput instruments use an applicator comb to apply a series of samples in a single line on the substrate. Such an applicator comb, having a design using squared-off teeth, is described in U.S. Pat. No. 6,544,395, which is hereby incorporated by reference herein in its entirety. After the sample is applied in this technique, it is electrophoresed to separate the components of the sample. The result is a parallel series of channels of sample proteins or other biomolecules or biological particles in the gel.

After the electrophoretic separation step, the entire reaction zone is typically saturated with the antiserum since the antigen (e.g., the protein fraction, the lipoprotein fraction, etc.) resolution may have occurred virtually at any position along the reaction zone. The entire zone is typically covered because otherwise the antibody-antigen reaction may not occur.

Furthermore, a sufficient amount of antiserum is often deposited to ensure that the antigen will react with the antibody. Thus, it is conventional to apply excess amounts of antiserum. However, many prior art techniques and apparatus for applying the antiserum fail to properly control the flow of the antiserum. For example, in IFE, or any other procedure where various reagents are deposited on distinct zones of the same gel, the use of excess amounts of reagent can cause the reagent to “overflow” from one zone onto an adjacent zone. If the reagents in two adjacent zones each “overflow” their respective zones, the reagent which “overflows” one zone can contact the reagent which “overflows” from an adjacent zone, resulting in “cross-contamination” between zones or otherwise compromising the test results for one or more zones.

A method of applying antisera wherein a template mask is placed over the gel substrate and antisera is applied to the gel lanes is described in EPO Patent No. 1 048 949, which is hereby incorporated by reference herein in its entirety. This method can lead to substantial losses of antisera volume as sufficient liquid may be applied to the lanes to complete antisera flow along the entire length, though only a thin layer is required to interact with the separated biomolecules in the gel substrate.

Additional gel-based techniques for applying antisera are described in U.S. Pat. No. 7,989,215; U.S. Pat. No. 5,464,521; EPO Patent No. 1 335 201; and U.S. Pat. No. 4,668,363, all of which are incorporated herein by reference in their entirety. However, these techniques all include devices that require the reagent to be suspended above the entire length of the pattern during reagent absorption. Given the expense of reagents and antisera, these techniques are economically wasteful as large amounts of the reagent must be removed and discarded.

In techniques like immunofixation, the gel must be put in contact with antisera containing antibodies that target the sample components. Antisera is typically expensive and difficult to obtain. Thus, there is a desire in the market to use as little antisera as possible to produce acceptable results.

Methods have been proposed for preserving antisera volume, which include spreading a thin film on the surface of the electrophoresis gel. These methods, however, fail to save the antisera that is applied indiscriminately between lanes. Alternatively, individual lanes could be contacted with channels of antisera to conserve antisera volume. This method, however, is not scalable, requiring a skilled individual to apply liquid to multiple gel lanes.

The present invention is directed to overcoming these and other deficiencies in the art.

### SUMMARY OF THE INVENTION

One aspect of the present invention relates to a cylindrical cam device including an axle and a plurality of disk portions disposed about the axle. The plurality of disk portions define a plurality of interstitial regions disposed between the plurality of disk portions. Each of the plurality of disk portions comprises a radial edge. The radial edge of each of the plurality of disk portions comprises a material or structure capable of retaining a liquid and releasing at least a portion of the liquid onto a substrate.

Another aspect of the present invention relates to a method for facilitating electrophoretic analysis of biological samples comprising absorbing one or more liquids onto at least a portion of a radial edge of each of a plurality of disk portions disposed about an axle defining an axis. A portion of the radial edge of each of the plurality of disk portions is contacted to respective lanes of an electrophoretic gel substrate comprising one or more biological particles. The axle is rotated, thereby rotating the radial edge of each of the plurality of disk portions about the axis and along each of the respective lanes of the electrophoretic gel substrate. At least a portion of the one or more liquids is deposited from the radial edge of each of the plurality of disk portions along each of the respective lanes of the electrophoretic gel substrate.

This invention provides a number of advantages, including providing improved performance for deposition of a liquid onto an electrophoresis gel substrate. In particular, various embodiments of this invention offer improvements in deposition of a reagent, such as an antiserum, to various gel lanes on an electrophoresis gel plate in order to facilitate electrophoresis analysis of biological samples deposited on the plate; provide an accurate deposition to the individual gel lanes on the electrophoresis gel plate to provide improved preservation of antisera volume, while also providing a sufficient amount of antisera to obtain the desired results; allow for the simultaneous deposition along several distinct lanes to improve efficiency in high throughput laboratories; eliminate the need for complex and static rigid templates which can mechanically insult the gel; use smaller volumes of reagent leading to minimized leaking and contamination of adjacent areas; and offers more efficiencies, as there are no additional steps required remove and dispose unused reagent/antisera.

### BRIEF DESCRIPTION OF THE DRAWINGS

FIG. 1 is a side perspective view of one embodiment of a cylindrical cam device of the present invention.

### DETAILED DESCRIPTION

The present invention relates to a cylindrical cam device and a method for facilitating electrophoretic analysis of biological samples utilizing the cylindrical cam device. More specifically, the present invention herein is a cylinder cam for gel electrophoresis using parallel application of samples of a reagent, such as antisera, to an electrophoretic gel substrate.

One aspect of the present invention relates to a cylindrical cam device including an axle and a plurality of disk portions disposed about the axle. The plurality of disk portions define a plurality of interstitial regions disposed between the plurality of disk portions. Each of the plurality of disk portions comprises a radial edge. The radial edge of each of the plurality of disk portions comprises a material or structure capable of retaining a liquid and releasing at least a portion of the liquid onto a substrate.

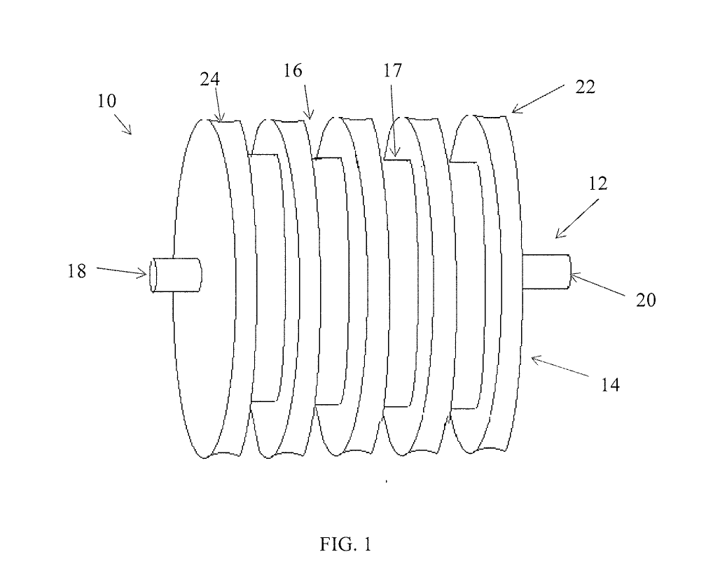

FIG. 1 shows a side perspective view of one embodiment of a cylindrical cam device 10 of the present invention. Cylindrical cam device 10 may be utilized for the absorption and deposition of liquid samples on an electrophoresis gel plate. In particular, the cylindrical cam device 10 may be utilized for the absorption and deposition of a reagent, such as an antiserum by way of example, to individual gel lanes on an electrophoresis plate as described in EPO Patent No. 1,048,949, which is incorporated by reference herein.

Cylindrical cam device 10 includes an axle 12, a plurality of disk portions 14, a plurality of interstitial regions 16, and a plurality of interstitial disk portions 17, although cylindrical cam device 10 may include other elements in other configurations. Axle 12 is an elongate cylindrical rod that extends between a first end 18 and a second end 20. Axle 12 is configured to support the plurality of disk portions 14 disposed thereon. First end 18 and second 20 of axle 12 allow for manipulation of the cylindrical cam device 10. In one example, first end 18 and second end 20 of axle 12 extend beyond the plurality of disk portions 14, such that the plurality of disk portions 14 may be rotated by rotating the axle 12 at either the first end 18 or the second end 20, or both. Axle 12 may be rotated manually, although in other embodiments, axle 12 may be connected to and mechanically rotated by automated instrumentation.

The plurality of disk portions 14 are cylindrical disks disposed about the axle 12. Each of the disk portions 14 includes a radial edge 22 around the circumference of the disk portion 14. The radial edge 22 has a substantially concave shape which forms a recessed portion 24 in each of the plurality of disk portions 14. The recessed portion 24 serves as aliquoting channels and are configured to receive and retain a liquid for deposition on a substrate, although the disk portions 14 may include other elements in other configurations to receive and retain a liquid therein. The diameter of each of the plurality of disk portions 14 is proportional to a volume of liquid to be retained and released from the disk portion 14. The volume required may be modified through the use of appropriate excipients to complement surface tensions of the disk portions 14, the reagent, and the gel utilized. In one embodiment, each of the disk portions 14 disposed along the axle 12 has the same diameter.

The plurality of disk portions 14 are disposed parallel to one another along the length of axle 12. Although FIG. 1 illustrates five disk portions 14 disposed on axle 12, it is to be understood that other numbers of disk portions 14 may be utilized. In one example, axle 12 may include at least ten disk portions 14. In another embodiment, axle 12 may include at least twenty disk portions 14. In yet a further embodiment, axle 20 may include at least forty disk portions 14. The plurality of disk portions 14 are equally spaced apart to correspond to parallel lanes on an electrophoretic gel substrate, although the disk portions 14 may be disposed in other configurations to be utilized with electrophoretic gel substrates known in the art.

Interstitial regions 16 are located, and define the space between, the plurality of disk portions 14. The distance between adjacent disk portions 14 defined by the interstitial regions 16 is configured based on the width of the parallel lanes on the electrophoretic gel substrate as described further below. In one example, the interstitial regions 16 include interstitial disk portions 17 located therein. The interstitial disk portions 17 are cylindrical disks disposed about the axle 12, which are located in the interstitial regions 16 between the disk portions 14, although in another embodiment, the axle 12 may be exposed in the interstitial regions 16. The interstitial disk portions 17 have a diameter that is smaller than the diameter of the two adjacent disk portions of the plurality of disk portions 14. The interstitial portions 17 may be constructed of the same material as the disk portions 14, although different materials may be utilized for the interstitial portions 17 and the plurality of disk portions 14.

Another aspect of the present invention relates to a method for facilitating electrophoretic analysis of biological samples comprising absorbing one or more liquids onto at least a portion of a radial edge of each of a plurality of disk portions disposed about an axle defining an axis. A portion of the radial edge of each of the plurality of disk portions is contacted to respective lanes of an electrophoretic gel substrate comprising one or more biological particles. The axle is rotated, thereby rotating the radial edge of each of the plurality of disk portions about the axis and along each of the respective lanes of the electrophoretic gel substrate. At least a portion of the one or more liquids is deposited from the radial edge of each of the plurality of disk portions along each of the respective lanes of the electrophoretic gel substrate.

Referring again to FIG. 1, in operation, one or more liquids are loaded or absorbed onto recessed portions 24 of radial edges 22 of each of the plurality of disk portions 14. The one or more liquids may include a reagent, such as an antiserum. In one example, the one or more liquids are antibodies bound to a signal producing molecule capable of producing a detectable signal when the one or more antibodies are bound to an antigen. The one or more liquids may be loaded onto the disk portions by pipetting the liquids onto recessed portions 24 of the radial edges 22. Alternatively, the one or more liquids may be loaded onto disk portions 14 by contacting at least a portion of each radial edge 22 to a reservoir containing the one or more liquids.

Next, a portion of radial edge 22 of each of the plurality of disk portions 14 is contacted to a respective lane of an electrophoretic gel substrate defining a plurality of reaction zones. The plurality of lanes contain one or more biological particles, such as a patient fluid sample, the biological particles including one or more antigens recognizable by the antibodies in the one or more liquids loaded onto the disk portions 14 as described above. The biological particles may be deposited on the electrophoretic gel substrate as described in U.S. Patent Application Ser. No. 14/455,612, which is hereby incorporated herein by reference in its entirety.

The axle 12 of the cylindrical cam device 10 is then rotated to rotate radial edges 22 of each of the plurality of disk portions 14 along a respective lane of the electrophoretic gel substrate. The axle 12 may be manually rotated along the electrophoretic substrate, or automatically rotated utilizing a mechanical device coupled to the axle 12.

As the axle 12 is rotated, such that radial edges 22 of the each of the plurality of disk portions 14 contact the reaction zone defined by the respective lane. In another embodiment, radial edge 22 maintains separation from the gel so that only the absorbed liquid is in contact with the gel. The one or more liquids, which are loaded onto the disk portions 14 as set forth above, are deposited from recessed portions 24 onto the respective lanes of the gel substrate. Recessed portions 24 expose a mobile “aliquot” of liquid, such as a reagent, to the reaction zones. The liquids are deposited from recessed portions 24 of the plurality of disk portions 14 to the reaction zones on the electrophoretic gel substrate, which facilitates a reaction between the antigens in the biological sample and the antibodies deposited by the cylindrical cam device 10. In instances when the primary intended reagent is antisera, this mobile approach permits mixing, which maximizes antigen-antibody interaction. In one example, the liquids are deposited to cover substantially all of the reaction zones on the electrophoretic gel substrate.

Next, the antibodies from the liquids deposited on the substrate are allowed to incubate with corresponding antigens from the biological particles for a time interval. After the elapsed time interval, excess deposited liquid is washed away from the reaction zone using known methods. Antigens bound to the one or more antibodies may then be detected utilizing imaging techniques such as staining, fluorescent, radioactive or other techniques, to identify molecules and particles of interest within the biological particles on the gel substrate.

A further aspect of the present invention relates to a system comprising: (a) a cylindrical cam device as in FIG. 1, (b) an electrophoresis platform with means to support an electrophoretic gel, (c) an electrophoretic gel such as an agarose or polyacrylamide gel to rest on the platform, and (d) antisera solution for application to the gel by the cylindrical cam device. In combination, the cam device has antisera solution on its outer edges and contacts the electrophoretic gel, which is supported by a platform to disperse the antisera solution on the gel. In additional embodiments, the circumference of the cam outer edge is less than or equal to the length of the gel. The circumference of the cam outer edge may be about 100%, 95%, 90%, 85%, or 80% of the length of the gel to optimize application of antisera reagent to the gel surface.

The system may further comprise mechanical means to hold the cam such as a rail, frame, or mechanical arm. The mechanical means can hold the cam in a consistent position relative to the surface of the gel. It preferably allows the cam to be drawn across the surface of the gel at constant position relative to the surface of the gel. The mechanical means may have an automatic operation facility to move the cam across the gel without human intervention.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed is:

1. A cylindrical cam device comprising:
an axle; and
a plurality of disk portions disposed about the axle and defining a plurality of interstitial regions disposed between the plurality of disk portions, wherein each of the plurality of disk portions comprises a radial edge and the radial edge of each of the plurality of disk portions comprises a material or structure capable of retaining a liquid and releasing at least a portion of the liquid onto a substrate.

2. The device of claim 1, wherein the radial edge of each of the plurality of disk portions has a substantially concave shape comprising a recessed portion configured to retain the liquid.

3. The device of claim 1 further comprising:
a plurality of interstitial portions each disposed about the axle at one of the interstitial regions and having a smaller diameter than a diameter of each of an adjacent two of the plurality of disk portions.

4. The device of claim 1, wherein the plurality of disk portions are spaced apart to substantially correspond to lanes of an electrophoretic gel substrate.

5. The device of claim 1, wherein the diameter of each of the disk portions is proportional to a volume of the liquid to be released onto the substrate.

6. The device of claim 1, wherein the axle extends beyond the plurality of disk portions toward at least one of a first end or a second end of the axle and the axle and the plurality of disk portions are rotatable by rotating the axle at the first end or the second end of the axle.

7. The device of claim 1 wherein the plurality of disk portions comprises at least 10 disk portions.

8. The device of claim 1 wherein the plurality of disk portions comprises at least 20 disk portions.

9. The device of claim 1 wherein the plurality of disk portions comprises at least 40 disk portions.

10. A method for facilitating electrophoretic analysis of biological samples, the method comprising:
loading one or more liquids onto at least a portion of a radial edge of each of a plurality of disk portions disposed about an axle defining an axis;
contacting a portion of the radial edge of each of the plurality of disk portions to respective lanes of an electrophoretic gel substrate comprising one or more biological particles;
rotating the axle, thereby rotating the radial edge of each of the plurality of disk portions about the axis and along each of the respective lanes of the electrophoretic gel substrate; and
depositing at least a portion of the one or more liquids from the radial edge of each of the plurality of disk portions along each of the respective lanes of the electrophoretic gel substrate.

11. The method of claim 10, wherein the loading further comprises:
pipetting the one or more liquids onto at least a portion of the radial edge of each of the plurality of disk portions.

12. The method of claim 10, wherein the loading further comprises:
contacting at least a portion of the radial edge of each of the plurality of disk portions to a respective one of a plurality of reservoirs, each comprising one or more of the liquids.

13. The method of claim 10, wherein the one or more liquids comprise one or more antibodies and the biological particles comprise one or more antigens recognizable by the one or more antibodies.

14. The method of claim 13, wherein the one or more antibodies are bound to a signal producing molecule capable of producing a detectable signal when the one or more antibodies are bound to an antigen.

15. The method of claim 13 further comprising:
detecting one or more of the antigens bound to one or more of the antibodies.

16. The method of claim 13, wherein each of the plurality of lanes defines one of a plurality of reaction zones.

17. The method of claim 16, wherein the depositing step facilitates a reaction between one or more of the antigens of each of the plurality of reaction zones and one or more of the antibodies.

18. The method of claim 17 further comprising:
incubating the one or more of the antibodies and one or more of the antigens for a time interval; and
washing at least a portion of the deposited one or more liquids from each of the plurality of reaction zones subsequent to the time interval elapsing.

19. The method of claim 18, wherein the depositing step further comprises:
depositing the at least a portion of the one or more liquids to cover substantially all of each of the reaction zones.
